(19) United States
(12) Patent Application Publication
(10) Pub. No.: US 2023/0382347 A1
(43) Pub. Date: Nov. 30, 2023

(54) VEHICLE ANTI-THEFT DEVICE

(71) Applicant: Avo Demirjian, Toronto (CA)

(72) Inventor: Avo Demirjian, Toronto (CA)

(21) Appl. No.: 17/664,901

(22) Filed: May 25, 2022

(51) Int. Cl. B60R 25/20; B60R 25/04; B60R 25/40

(52) U.S. Cl. CPC B60R 25/209; B60R 25/04; B60R 25/403; B60R 2325/20; B60R 2325/105

(57) ABSTRACT

A vehicle anti-theft device that is operable to inhibit the operation of a keyless vehicle module wherein the present invention includes a first mode and a second mode. The present invention includes a second controller wherein the second controller is installed in a suitable location within a vehicle. The second controller is electrically coupled to the wiring harness of the vehicle wherein a circuit portion thereof is utilized to supply direct current power to the second controller. A key fob is provided wherein the key fob is operably coupled to the second controller. The key fob includes a first switch and a second switch wherein the first switch and second switch transition the present invention between the first mode and second mode. In the first mode of the present invention the second controller inhibits direct current flow to the first controller and as such renders the keyless vehicle module inoperable.

### FIELD OF THE INVENTION

The present invention relates generally to vehicle theft prevention, more specifically but not by way of limitation, a vehicle anti-theft device that is configured to inhibit operation of the radio frequency (RF) controller of the vehicle wherein the present invention temporarily interrupts power to the controller wirelessly coupled to the vehicle RF controller.

### BACKGROUND

As is known in the art car theft amount in North America has been on the rise in the last few years. In 2020, in the number of vehicles stolen was up 11.8% to the highest rate since 2009. The cost to individuals and insurers is billions of dollars and this results in higher insurance costs for individual policy owners. Additionally, having a vehicle stolen results in numerous inconveniences that can result in personal distress and financial hardships. Furthermore, many vehicle owners lose personal belongings that were stored in the vehicle which are typically never recovered and result in additional damage both financially and emotionally.

One issue with current vehicle technology is the radio frequency (RF) key fob that most new cars now use for both locking/unlocking as well as ignition of the vehicle. While the automobile industry transitioned to these devices in order to make vehicles more secure from the traditional key, unfortunately criminals have deployed technology that is able to steal codes from the key fobs used by the vehicle owners. The RF key fobs utilize a specifically coded frequency of RF for their paired vehicle. Technology has been developed that facilitate the ability for criminals to be within a couple hundred feet of a key fob and when activated the technology is deployed to obtain the signal and can then be replicated into a duplicate key fob. This duplicate key fob is manufactured without the vehicle owner's knowledge and is subsequently utilized to break into the vehicle and either steal the vehicle or contents disposed therein.

Accordingly, there is a need for a vehicle anti-theft device that is configured to prevent utilization of the key fob or any duplicate thereof so as to inhibit access to or operation of the vehicle controlled by the paired key fob.

### SUMMARY OF THE INVENTION

It is the object of the present invention to provide a vehicle anti-theft device that is configured to inhibit operation of the paired RF key fob for the vehicle wherein the present invention includes a first controller.

Another object of the present invention is to provide an anti-theft device operable to inhibit operation of a pair RF key fob so as to inhibit access to the vehicle to which the key fob is paired wherein the present invention includes a second controller.

A further object of the present invention is to provide a vehicle anti-theft device that is configured to inhibit operation of the paired RF key fob for the vehicle wherein the first controller is operable to wirelessly couple to a paired key fob for the vehicle to provide access to and operation thereof.

Still another object of the present invention is to provide an anti-theft device operable to inhibit operation of a pair RF key fob so as to inhibit access to the vehicle to which the key fob is paired wherein the second controller is electrically coupled to the first controller.

An additional object of the present invention is to provide a vehicle anti-theft device that is configured to inhibit operation of the paired RF key fob for the vehicle wherein the second controller is independently operated by a second key fob.

Yet a further object of the present invention is to provide an anti-theft device operable to inhibit operation of a pair RF key fob so as to inhibit access to the vehicle to which the key fob is paired wherein the second key is provided with an on and off switch on the housing thereof.

Another object of the present invention is to provide a vehicle anti-theft device that is configured to inhibit operation of the paired RF key fob for the vehicle wherein the second controller is operable in a first mode and in a second mode.

Still another object of the present invention is to provide an anti-theft device operable to inhibit operation of a pair RF key fob so as to inhibit access to the vehicle to which the key fob is paired wherein in the first mode the second controller permits voltage flow to the first controller.

An additional object of the present invention is to provide a vehicle anti-theft device that is configured to inhibit operation of the paired RF key fob for the vehicle wherein in the second mode the second controller inhibits voltage flow to the first controller.

Still a further object of the present invention is to provide an anti-theft device operable to inhibit operation of a pair RF key fob so as to inhibit access to the vehicle wherein the on/off switch on the second key fob provides an interface to operate the first mode and second mode of the second controller.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of the second controller and an exemplary wiring diagram for installation thereof into a vehicle and wherein the exemplary wiring diagram of the vehicle is further continued on page two of the submitted drawings; and

FIG. 2 is a perspective view of the second controller mechanically coupled to the key fob operably paired therewith.

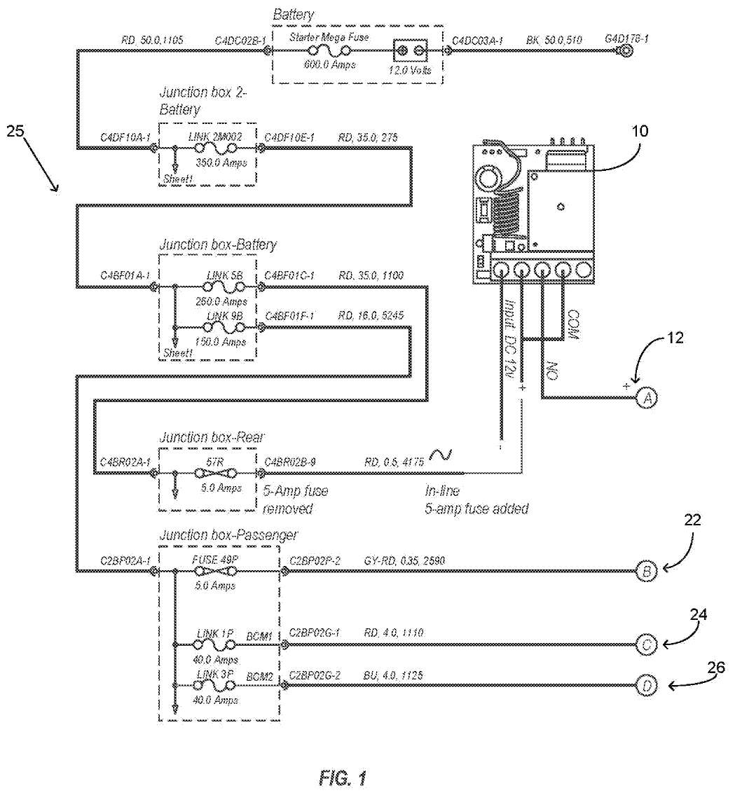

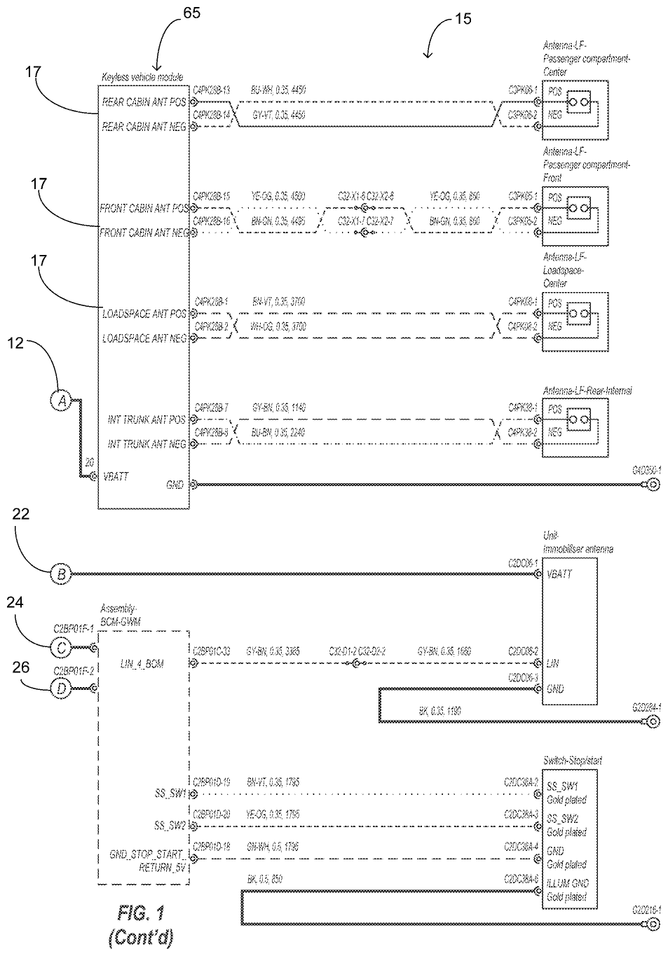

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle anti-theft device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

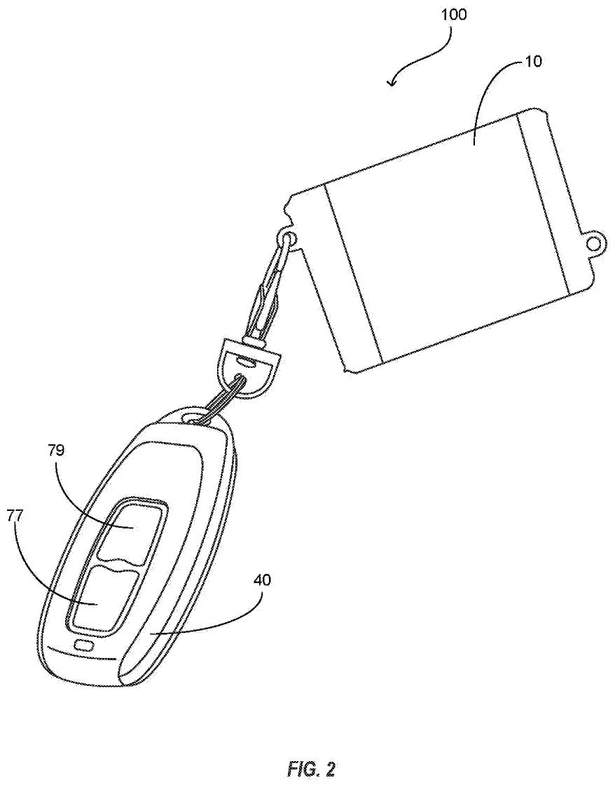

Referring in particular to the Figures submitted as a part hereof, the vehicle anti-theft device 100 includes a second controller 10 wherein the second controller is illustrated herein in FIG. 2 in its physical embodiment. As is further discussed herein, the second controller 10 is operable to be installed in a suitable location in a vehicle wherein the second controller 10 is subsequently electrically coupled thereto. The second controller 10 is wirelessly coupled to a key fob 40 wherein the key fob 40 is configured to provide operation of the second controller 10. It should be understood within the scope of the present invention that the second controller 10 could be manufactured in alternate sizes and shapes in order to be mounted in alternate locations of the vehicle. The FIG. 2 submitted herewith is exemplary only and it should be understood that the second controller 10 is not mechanically coupled to the key fob 40 ensuing installation of the vehicle anti-theft device 100. FIG. 2 is illustrated solely for demonstration purposes and the key fob 40 is possessed by a user of the vehicle anti-theft device 100 and the second controller 10 is installed into a vehicle and electrically coupled thereto.

The key fob 40 includes a first switch 77 and a second switch 79. The first switch 77 and the second switch 79 are operable to transition the vehicle anti-theft device 100 between a first mode and a second mode. In the first mode of the vehicle anti-theft device 100, which is activated by the first switch, the second controller 10 interrupts power to the first controller 15. The first controller 15 is operably coupled to a keyless vehicle module 65 wherein the keyless vehicle module 65 provides wireless operation of the features of the first controller 15 such as but limited to vehicle operation and vehicle access. In the first mode of the vehicle anti-theft device 100 the key fob 40 inhibits flow of direct current power at location 12. It should be understood that location 12 is exemplary and that alternate wiring techniques could be employed during installation of the vehicle anti-theft device 100. The first mode of the vehicle anti-theft device 100 inhibits the necessary power to provide operation of the first controller 15. During activation of the first mode the vehicle anti-theft device 100 prevents utilization of the keyless vehicle module 65 and any operational feature thereof such as but not limited to vehicle access and vehicle ignition.

The second switch 79 of the key fob 40 places the vehicle anti-theft device 100 in its second mode. In the second mode of operation the vehicle anti-theft device 100 allows direct current to flow through location 12 and as such provide power to the first controller 15. In the second mode power is supplied to location 12 and as such the receivers 17 are operable to be controlled by the keyless vehicle module 65 and all operational features thereof. Locations 22, 24 and 26 illustrates an exemplary wiring diagram for the vehicle in which the keyless vehicle module 65 is installed. It should be understood within the scope of the present invention that the locations 22, 24 and 26 are exemplary circuits and that alternate wiring circuits could be employed. Circuit portion 25 is an exemplary power supply circuit present in the vehicle in which the keyless vehicle module 65 has been installed. Circuit portion 25 is operably coupled to second controller 10 and is configured to provide the necessary direct current power thereto. It should be understood that circuit portion is exemplary and that the alternate wiring could be provided dependent upon the vehicle and function to provide the necessary direct current power to the second controller 10. The circuit portion 25 is electrically coupled to a power source of the vehicle.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A vehicle anti-theft device that is operably coupled to a vehicle wherein the vehicle anti-theft device is operable in a first mode and a second mode and wherein the vehicle anti-theft device comprises:
a first controller, said first controller being installed in the vehicle, said first controller being electrically coupled to the vehicle, said first controller providing operational features for the vehicle;
a second controller, said second controller being installed in the vehicle, said second controller being electrically coupled to the first controller;
a key fob, said key fob being operably coupled to said second controller, said key fob configured to provide selection of the first mode and second mode of the present invention; and
Wherein in the first mode the first controller has direct current power flow restricted therefrom so as to inhibit operation thereof.

2. The vehicle anti-theft device as recited in claim 1, and further including a keyless vehicle module, said keyless vehicle module operably coupled to the first controller, said keyless vehicle module configured to execute operational features of the first controller.

3. The vehicle anti-theft device as recited in claim 2, wherein in the second mode the second controller permits direct current flow to the first controller.

4. The vehicle anti-theft device as recited in claim 3, wherein the key fob includes a first switch and a second switch wherein the first switch and second switch provide an interface to transition between the first mode and the second mode.

5. The vehicle anti-theft device as recited in claim 4, wherein the operational features of the first controller include vehicle access and vehicle ignition.

6. The vehicle anti-theft device as recited in claim 5, and further including a circuit portion, said circuit portion being electrically coupled to a power source of the vehicle.
